(19) United States
(12) Patent Application Publication
(10) Pub. No.: US 2024/0414689 A1
(43) Pub. Date: Dec. 12, 2024

(54) COMMUNICATION METHOD AND ELECTRONIC DEVICE

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/702,525

(22) PCT Filed: Oct. 22, 2021
(86) PCT No.: PCT/CN2021/125905

§ 371 Date: Apr. 18, 2024

(51) Int. Cl. H04W 64/00; H04W 8/24; H04W 84/12

(52) U.S. Cl. CPC H04W 64/006; H04W 8/24; H04W 84/12

(57) ABSTRACT

The present disclosure provides a communication method and a communication apparatus. The communication method comprises: determining a first message frame, the first message frame comprising information used for identifying the capabilities that can be supported during wireless local area network perception by the device that sends the first message frame; and sending the first message frame. The technical solution provided in the embodiments of the present disclosure can facilitate the implementation of wireless local area network perception.

### CROSS-REFERENCE TO RELATED APPLICATIONS

The present application is a U.S. National Stage of International Application No. PCT/CN2021/125905 filed on Oct. 22, 2021, the entire contents of which are incorporated herein by reference for all purposes.

### TECHNICAL FIELD

The present disclosure relates to the field of wireless communication, and more specifically, to a communication method and a communication device applied to wireless local area network sensing.

### BACKGROUND

The wireless local area network (WLAN) has characteristics such as flexibility, mobility and low cost. With the development of communication technology and the growth of user needs, WLAN applications have been further studied. For example, WLAN sensing is currently being studied, and the main applications thereof include location discovery in a dense environment (home and corporate environments), proximity detection, and presence detection.

### SUMMARY

Aspects of the present disclosure will address at least the above problems and/or drawbacks. Various embodiments of the present disclosure provide the following technical solutions:

An example embodiment of the present disclosure provides a communication method. The communication method includes: determining a first message frame, wherein the first message frame includes information used to identify a capability which a device sending the first message frame can support in a wireless local area network (WLAN) sensing procedure; and transmitting the first message frame.

An example embodiment of the present disclosure provides a communication method. The communication method includes: receiving a first message frame, wherein the first message frame includes information used to identify a capability which a device sending the first message frame can support in a wireless local area network (WLAN) sensing procedure; and performing a communication operation based on the first message frame.

An example embodiment of the present disclosure provides a communication device. The communication device includes: a processing module configured to determine a first message frame, wherein the first message frame includes information used to identify a capability which a device sending the first message frame can support in a wireless local area network (WLAN) sensing procedure; and a transceiver module configured to transmit the first message frame.

An example embodiment of the present disclosure provides a communication device. The communication device includes: a transceiver module configured to receive a first message frame, wherein the first message frame includes information used to identify a capability which a device sending the first message frame can support in a wireless local area network (WLAN) sensing procedure; and a processing module configured to perform a communication operation based on the first message frame.

An example embodiment of the present disclosure provides an electronic device. The electronic device includes a memory, a processor and a computer program stored on the memory and runnable on the processor. The processor, when executing the computer program, implements the method described above.

An example embodiment of the present disclosure provides a computer-readable storage medium. The computer-readable storage medium has stored thereon a computer program that, when being executed by a processor, implements the method described above.

### BRIEF DESCRIPTION OF THE DRAWINGS

These and other features of embodiments of the present disclosure will become more apparent by describing in detail example embodiments of the present disclosure with reference to the accompanying drawings, in which:

FIGS. 1 (a), (b) and (c) illustrate an example manner of WLAN sensing;

FIG. 2 is a flowchart of a communication method according to an example embodiment;

FIG. 3 is a flowchart of another communication method according to an example embodiment; and

FIG. 4 is a block diagram of a communication device according to an example embodiment.

### DETAILED DESCRIPTION

The following description with reference to the accompanying drawings is provided so that various embodiments of the present disclosure as defined by the appended claims and their equivalents may be fully understood. Various embodiments of the present disclosure include various specific details, which however are to be considered exemplary only. In addition, descriptions of well-known techniques, functions, and constructions may be omitted for clarity and brevity.

Terms and phrases used in the present disclosure are not limited to their written meanings, but are used only by the inventor to enable a clear and consistent understanding of the present disclosure. Accordingly, for a person skilled in the art, the description of various embodiments of the present disclosure is provided for illustrative purposes only and is not intended to be limiting.

It is to be understood that singular forms “a”, “an”, “said” and “the” as used herein may also include plural forms unless the context clearly indicates otherwise. It is to be further understood that the term “including” as used in the present disclosure refers to the presence of described features, integers, steps, operations, elements and/or components, but does not preclude the presence or addition of one or more other features, integers, steps, operations, elements, components and/or groups thereof.

It is to be understood that although the terms “first”, “second” or the like may be used herein to describe various elements, these elements should not be limited by these terms. These terms are only used to distinguish one element from another element. Thus, without departing from the teachings of the example embodiments, a first element discussed below may be referred to as a second element.

It is to be understood that when an element is referred to as being “connected” or “coupled” to another element, it may be directly connected or coupled to the other element, or there may be an intermediate element therebetween. In addition, the “connected” or “coupled” as used herein may include wirelessly connected or wirelessly coupled. The terms “and/or” or the expression “at least one of . . . ” as used herein include any and all combinations of one or more of the relevant listed items.

Unless otherwise defined, all terms used herein, including technical and scientific terms, have the same meaning as generally understood by a person skilled in the art to which the present disclosure belongs.

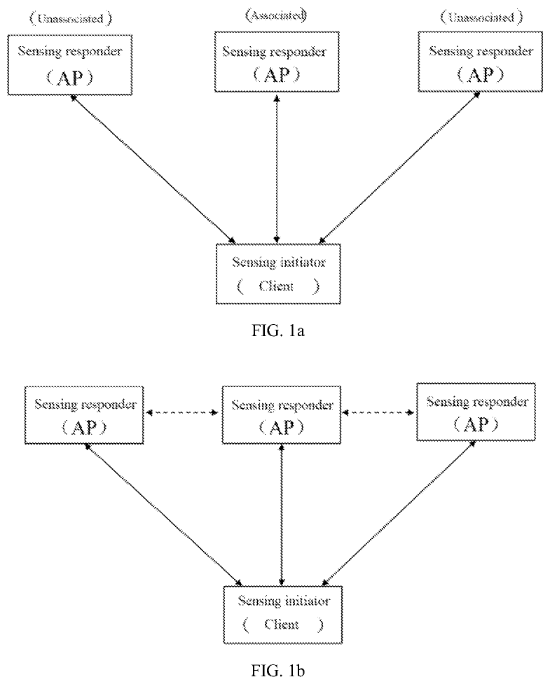

FIGS. 1 (a), (b) and (c) illustrate an example manner of WLAN sensing.

The process of WLAN sensing may be as follows: an initiator initiates the WLAN sensing (e.g., initiates a WLAN sensing session), a plurality of responders may respond to the same, the specific possible manners of which may be as shown in FIGS. 1 (a), 1 (b), and 1 (c).

Referring to FIG. 1 (a), when the initiator of the WLAN sensing (e.g., a client) initiates the WLAN sensing, a plurality of associated or unassociated responders of the WLAN sensing (e.g., three access points (APs)) may make a response. The term “associated” may mean that the initiator and the responder have established an association connection for communication, and the term “unassociated” may mean that the initiator and the responder have not established an association connection for communication.

As an example, the client may include, but is not limited to, a cellular phone, a smart phone, a wearable device, a computer, a personal digital assistant (PDA), a personal communication system (PCS) device, a personal information manager (PIM), a personal navigation device (PND), a global positioning system (GPS), a multimedia device, an Internet of Things (IoT) device, and the like.

The AP is a wireless switch for a wireless network, and is also an access device for the wireless network. The AP may include a software application and/or a circuitry so that other types of nodes in the wireless network may communicate with objects outside or inside the wireless network via the AP. As an example, the AP may be a terminal device or network device provided with a Wi-Fi (Wireless Fidelity) chip.

FIG. 1 (b) is similar to FIG. 1 (a), except that in FIG. 1 (b), the communication may be carried out between respective responders (APs).

Referring to FIG. 1 (c), both the WLAN sensing initiator and the WLAN sensing responder may be clients, and they may communicate with each other by connecting to the same AP.

Although it is illustrated in FIGS. 1 (a), 1 (b), and 1 (c) that the client serves as the initiator and the AP serves as the responder, however, the present disclosure is not limited thereto, for example, the AP may serve as the initiator and the client may serve as the responder. Further, the number of initiators and responders is not limited to that shown in FIGS. 1 (a), 1 (b), and 1 (c).

The WLAN sensing procedure may be initiated by the initiator, for example, the initiated WLAN sensing session may include one or more of a setup phase, a measurement phase, a reporting phase, and s termination phase.

In the setup phase, the sensing session is established, and an operation parameter associated with the sensing session is determined and exchanged between the devices. In the measurement phase, a sensing measurement may be performed. In the reporting phase, the result of the sensing measurement may be reported. In the termination phase, the device stops performing the measurement and terminates the sensing session.

There may be a plurality of sensing measurement events in the sensing measurement phase, and in each sensing measurement event, there may be a sensing transmitter and a sensing receiver. A station (e.g., an AP device or a non-AP device) may assume a plurality of roles in the WLAN sensing procedure. Further, each of the sensing initiator and the sensing responder as shown in FIGS. 1 (a), (b) and (c) may act as the sensing transmitter, the sensing receiver, both the sensing transmitter and the sensing receiver, or neither the sensing transmitter nor the sensing receiver in the WLAN sensing procedure. However, in the related art, there is no mechanism for defining how the station participates in the WLAN sensing, and there is no mechanism for defining a capability of the station supporting a sensing measurement method either.

In view of the above, a communication method and a communication device are provided in accordance with the concept of an embodiment of the present disclosure to address at least the above technical problem.

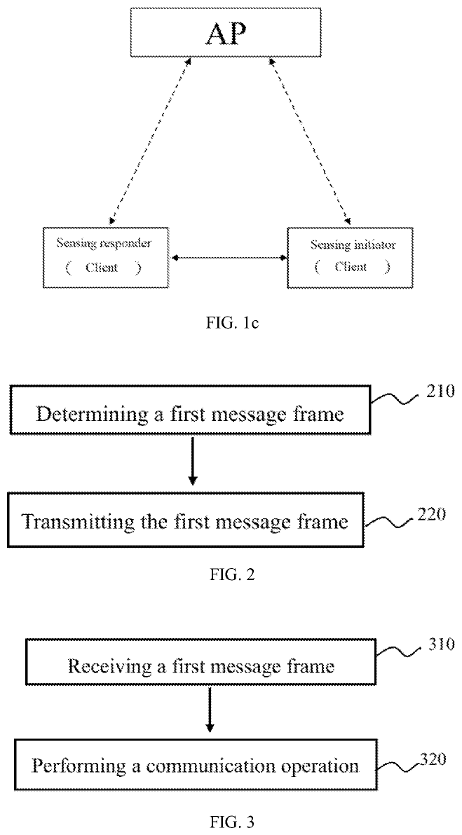

FIG. 2 is a flowchart of a communication method according to an example embodiment. The communication method shown in FIG. 2 may be applied to any station. In an embodiment of the present disclosure, the station may be a device that supports a sub-7 GHz spectrum, or a device that supports a 60 GHz spectrum, for example, a directional multi-giga (DMG) device or an enhanced directional multi-giga (EDMG) device. However, the present disclosure is not limited thereto, and a device that supports other spectrums is also included within the scope of the present disclosure.

Referring to FIG. 2, in step 210, a first message frame may be determined. The first message frame may include information used to identify a capability which the device transmitting the first message frame can support in a WLAN sensing procedure. The capability information may be referred to as “capability information regarding WLAN sensing” hereinafter.

According to an embodiment of the present disclosure, the first message frame may be a DMG beacon frame, a beacon frame, a probe request frame, a probe response frame, an association request frame, an association response frame, or the like. However, the present disclosure is not limited thereto, and other types of frames are also possible. In other words, the information of the capability that the device can support in the WLAN sensing procedure may be encapsulated in the first message frame in an access process (e.g., in the phase when the AP device is associating with the non-AP device). For convenience of description, the term “device” may refer to the device that transmits the first message frame hereinafter.

In an embodiment of the present disclosure, there may be various ways of determining the first message frame, for example, the first message frame may be generated or configured based on at least one of a channel state, a network condition, a load condition, a hardware capability of a transmitting/receiving device, a service type, and a relevant protocol provision, which is not specifically limited in the embodiment of the present disclosure. In an embodiment of the present disclosure, the first message frame may also be obtained from an external device, which is not specifically limited in the embodiment of the present disclosure.

According to an embodiment of the present disclosure, the capability information in the first message frame may include a first identification bit to identify a capability of the device supporting a sensing measurement based on a channel state information (CSI) threshold.

In an embodiment of the present disclosure, the sensing measurement based on the channel state information (CSI) threshold may be referred to as a CSI threshold-based measurement, which may refer to a method of comparing a CSI variation with a threshold in the WLAN sensing measurement procedure, and may be specifically defined in which: a difference between a current measured CSI and a previous measured CSI is quantified, and the difference is referred to as the CSI variation; a threshold to be used by the sensing receiver is defined (the threshold may be predefined, or may be defined by the sensing receiver, transmitter, initiator or responder); and by comparing the CSI variation with the threshold, the sensing receiver can transmit a feedback resulting from the large CSI variation to the sensing transmitter.

The CSI is an important parameter reflecting a quality state of a channel.

According to the above description, it can be seen that the sensing measurement based on the channel state information threshold may be applied to the WLAN sensing measurement phase to improve the accuracy of the WLAN sensing, and at the same time may reduce the signaling interaction and the processing time of the device because the receiver with a small threshold does not need to give feedback.

In the first message frame, the capability of the device supporting the sensing measurement based on the channel state information threshold may be identified by the first identification bit.

According to an embodiment of the present disclosure, the capability information in the first message frame may further include a second identification bit to identify a role of the device in the WLAN sensing procedure.

The device may act as a sensing initiator, a sensing responder, a sensing transmitter, a sensing receiver, both the sensing transmitter and the sensing receiver, or neither as the sensing transmitter nor as the sensing receiver in the WLAN sensing procedure.

In the first message frame, the role of the device in the WLAN sensing procedure may be identified by the second identification bit having a plurality of bits. Specifically, the second identification bit may include:
an initiator identification bit of a capability of the device supporting to act as an initiator in the WLAN sensing procedure;
a responder identification bit of a capability of the device supporting to act as a responder in the WLAN sensing procedure;
a transmitter identification bit of a capability of the device supporting to act as a transmitter in a sensing measurement phase of the WLAN sensing procedure; and
a receiver identification bit of a capability of the device supporting to act as a receiver in the sensing measurement phase.

The capability information including the first identification bit and the second identification bit described above may be encapsulated in the first message frame in various formats. For example, such capability information may be encapsulated in the first message frame in the form of an information element.

In an embodiment of the present disclosure, if the device supports the sub-7 GHz spectrum, such capability information may be encapsulated in the first message frame in the form of an extended capability information element. For example, a new bit may be defined in the extended capability information element to identify the information of the capability which the device can support in the WLAN sensing, as may be shown in Table 1 below.

TABLE 1
Capability regarding WLAN sensing in Extended
Capability Information Element

| Bit | Information | Notes |
|---|---|---|
| 98 | non-TB (triggered- | A setting of “1” identifies that the device |
| | based)/TB initiator | supports to act as a WLAN sensing |
| | | initiator, and a setting of “0” identifies |
| | | not supporting |
| 99 | non-TB/TB transmitter | A setting of “1” identifies supporting to |
| | | transmit a WLAN sensing measurement |
| | | frame, and a setting of “0” identifies not |
| | | supporting |
| 100 | non-TB/TB receiver | A setting of “1” identifies that the device |
| | | supports to receive a WLAN sensing |
| | | measurement frame, and a setting of “0” |
| | | identifies not supporting |
| 101 | non-TB/TB responder | A setting of “1” identifies that the device |
| | | supports to act as a WLAN sensing |
| | | responder, and a setting of “0” identifies |
| | | not supporting |
| 102 | CSI threshold-based | A setting of “1” identifies that the device |
| | measurement | supports a CSI threshold- based sensing |
| | | measurement, and a setting of “0” |
| | | identifies not supporting |

In Table 1, the “CSI threshold-based measurement” of the bit “102” may correspond to the first identification bit in the capability information described above. When the bit is set to a first value (for example, but not limited to, “1”), it may identify that the device supports the CSI threshold-based sensing measurement, i.e., when the device participates in the WLAN sensing measurement, it may use the method of comparing the threshold with the CSI variation as described above; and when the bit is set to a second value (for example, but not limited to, “0”), it may identify that the device does not support the CSI threshold-based sensing measurement.

In Table 1, the bit “98” to the bit “101” may correspond to the second identification bit in the capability information described above. The “non-TB/TB initiator” of the bit “98” may correspond to the initiator identification bit. When the bit is set to a first value (for example, but not limited to, “1”), it identifies that the device may act as the initiator to participate in the WLAN sensing, in which a trigger-based (TB) and/or non-triggered-based (non-TB) approach may be used in the WLAN sensing procedure; and when the bit is set to a second value (for example, but not limited to, “0”), the device may not act as the initiator in the WLAN sensing procedure. The bit “99” to the bit “101” in Table 1 correspond to the transmitter identification bit, the receiver identifier, and the responder identifier, respectively, and their meanings may be similar to the description of the bit “98” above, and repetitive descriptions are omitted herein for brevity.

It is to be understood that what is shown in Table 1 is merely exemplary and not a limitation of the present disclosure. For example, the extended capability information element shown in Table 1 may also include an identifier and length of extended capability, and information field of other capabilities.

In addition, in the case where the device supports the sub-7 GHz spectrum, identification information to identify the device which supports the sub-7 GHz spectrum may be further included in a capability information element of the first message frame. That is, in the case where the device supports the sub-7 GHz spectrum, the identification information to identify the device which supports the sub-7 GHz spectrum may be included in the capability information element of the first message frame, and the above mentioned capability information regarding the WLAN sensing may be included in the extended capability information element of the first message frame. By carrying the identification information regarding the supported spectrum (sub-7 GHz) and the capability information regarding the WLAN sensing in the first message frame, other devices (the devices receiving the first message frame) may be more fully informed about the capability information of the device that transmits the first message frame, and thus may perform the WLAN sensing more efficiently when needed.

In another embodiment of the present disclosure, in the case where the device supports the 60 GHz spectrum, the first message frame may include a DMG capability information element or an EDMG capability information element, in which the above mentioned capability information regarding the WLAN sensing may be included in the DMG capability information element or the EDMG capability information element.

For example, a “DMG direction WLAN sensing capability” field may be defined in the DMG capability information element, and the field may include the above mentioned capability information, e.g., in the format shown in Table 2 below.

TABLE 2
DMG direction WLAN sensing capability

| | | | | | |
|---|---|---|---|---|---|
| non-TB/TB | non-TB/TB | non-TB/TB | non-TB/TB | CSI threshold-based | reserved |
| initiator | transmitter | receiver | responder | measurement | |

The meanings and values of the respective sub-fields in Table 2 are similar to the information in Table 1 above, and repetitive descriptions thereof are omitted here for brevity.

For example, a new bit may be defined in the EDMG capability information element to identify the above capability information, which may, for example, have the format shown in Table 3 below.

TABLE 3
EDMG capability information element

| | | | | | | | | |
|---|---|---|---|---|---|---|---|---|
| . . . | EDMG | EDMG | non- | non- | non- | non- | CSI | reserved |
| | SC | OFDM | TB/TB | TB/TB | TB/TB | TB/TB | threshold- | |
| | Ranging | Ranging | initiator | transmitter | receiver | responder | based | |
| | Supported | Supported | | | | | measurement | |

In Table 3, a sub-field may be added in the EDMG capability information element to identify the capability information regarding the WLAN sensing, which may have a meaning similar to that described in Table 1, and the repetitive descriptions are omitted herein for brevity. In addition, Table 3 exemplarily shows sub-fields “EDMG SC Ranging Supported” and “EDMG OFDM Ranging Supported” in the EDMG capability information element to identify other supported capabilities, however, the present disclosure is not limited thereto, and Table 3 may further include more other sub-domains, such as First Path Beamforming Training Supported, and the like.

It is to be understood that the order and values of the capability information described above with reference to Tables 1 to 3 are only exemplary and not a limitation of the present disclosure, and thus various modifications may be made thereto.

For example, although it is shown in Tables 1 to 3 that, in identifying each of the initiator identification bit, the transmitter identification bit, the receiver identification bit, and the responder identification bit, a single bit is utilized to identify the role in both the “non-TB” and the “TB” manners, the present disclosure is not limited thereto. For example, separate identifying is possible.

For example, Table 1 may be modified into Tables 4 and 5 below.

TABLE 4
Capability regarding WLAN sensing in Extended
Capability Information Element

| Bit | Information | Notes |
|---|---|---|
| 98 | non-TB | A setting of “1” identifies that the device |
| | initiator | supports to act as a WLAN sensing non-TB |
| | | initiator, and a setting of “0” identifies not |
| | | supporting |
| 99 | non-TB | A setting of “1” identifies supporting to |
| | transmitter | transmit, in a non-TB manner, a WLAN sensing |
| | | measurement frame, and a setting of “0” |
| | | identifies not supporting |
| 100 | non-TB | A setting of “1” identifies that the device |
| | receiver | supports to receive, in a non-TB manner, a |
| | | WLAN sensing measurement frame, and a |
| | | setting of “0” identifies not supporting |
| 101 | non-TB | A setting of “1” identifies that the device |
| | responder | supports to act as a WLAN sensing non-TB |
| | | responder, and a setting of “0” identifies not |
| | | supporting |
| 102 | CSI threshold- | A setting of “1” identifies that the device |
| | based | supports a CSI threshold- based sensing |
| | measurement | measurement, and a setting of “0” identifies not |
| | | supporting |

In Table 4, the bit “102” corresponds to the first identification bit and has a meaning similar to that of the bit “102” in Table 1 above, and repetitive descriptions thereof are omitted for brevity. The bit “98” to bit “101” correspond to the second identification bit and have meanings and values similar to the meanings and values of the corresponding bits in Table 1, except whether or not they are of triggered-based, and repetitive descriptions thereof are omitted herein for brevity.

TABLE 5
Capability regarding WLAN sensing in Extended
Capability Information Element

| Bit | Information | Notes |
|---|---|---|
| 98 | TB initiator | A setting of “1” identifies that the device |
| | | supports to act as a WLAN sensing TB initiator, |
| | | and a setting of “0” identifies not supporting |
| 99 | TB transmitter | A setting of “1” identifies supporting to |
| | | transmit, in a TB manner, a WLAN sensing |
| | | measurement frame, and a setting of “0” |
| | | identifies not supporting |
| 100 | TB receiver | A setting of “1” identifies that the device |
| | | supports to receive, in a TB manner, a WLAN |
| | | sensing measurement frame, and a setting of “0” |
| | | identifies not supporting |
| 101 | TB responder | A setting of “1” identifies that the device |
| | | supports to act as a WLAN sensing TB |
| | | responder, and a setting of “0” identifies not |
| | | supporting |
| 102 | CSI threshold- | A setting of “1” identifies that the device |
| | based | supports a CSI threshold- based sensing |
| | measurement | measurement, and a setting of “0” identifies not |
| | | supporting |

In Table 5, the bit “102” corresponds to the first identification bit and has a meaning similar to that of the bit “102” in Table 1 above, and repetitive descriptions thereof are omitted for brevity. The bit “98” to bit “101” correspond to the second identification bit and have meanings and values similar to the meanings and values of the corresponding bits in Table 1, except whether or not they are of triggered-based, and repetitive descriptions thereof are omitted herein for brevity.

For example, Table 2 may be modified into Tables 6 and 7 below.

TABLE 6
DMG direction WLAN sensing capability

| | | | | | |
|---|---|---|---|---|---|
| non-TB | non-TB | non-TB | non-TB | CSI threshold-based | reserved |
| initiator | transmitter | receiver | responder | measurement | |

TABLE 7
DMG direction WLAN sensing capability

| | | | | | |
|---|---|---|---|---|---|
| TB | TB | TB | TB | CSI threshold-based | reserved |
| initiator | transmitter | receiver | responder | measurement | |

The meanings and values of the respective bits of the capability information regarding the WLAN sensing in Tables 6 and 7 may be similar to those in Tables 4 and 5, respectively, and the repetitive descriptions thereof are omitted here for brevity.

For example, Table 3 may be modified into Tables 8 and 9 below.

TABLE 8
EDMG capability information element

| | | | | | | | | |
|---|---|---|---|---|---|---|---|---|
| . . . | EDMG | EDMG | non-TB | non-TB | non-TB | non-TB | CSI | reserved |
| | SC | OFDM | initiator | transmitter | receiver | responder | threshold- | |
| | Ranging | Ranging | | | | | based | |
| | Supported | Supported | | | | | measurement | |

TABLE 9
EDMG capability information element

| | | | | | | | | |
|---|---|---|---|---|---|---|---|---|
| . . . | EDMG | EDMG | TB | TB | TB | TB | CSI | reserved |
| | SC | OFDM | initiator | transmitter | receiver | responder | threshold- | |
| | Ranging | Ranging | | | | | based | |
| | Supported | Supported | | | | | measurement | |

The meanings and values of the respective bits of the capability information regarding the WLAN sensing in Tables 8 and 9 may be similar to those in Tables 4 and 5, respectively, and the repetitive descriptions thereof are omitted here for brevity.

In addition, Tables 4 and 5 may be combined, or Tables 6 and 7 may be combined, or Tables 8 and 9 may be combined to identify the respective bits of the capability information regarding the WLAN sensing.

With continued reference to FIG. 2, in step 220, the first message frame may be transmitted. The device transmitting the first message frame may broadcast the capability information thereof such that a device receiving the first message frame may be informed of various capabilities in the WLAN sensing of the device transmitting the first message frame.

It is to be understood that the communication method shown in FIG. 2 is only exemplary and the present disclosure is not limited thereto, for example, the communication method shown in FIG. 2 may also include receiving another message frame, which may include information of a capability that the device transmitting said another message frame can support in the WLAN sensing procedure. For example, when the first message frame is an association request frame, said another message frame may be an association response frame.

The communication method shown in FIG. 2 may enable a device to broadcast the capability information value thereof during the access process, so that the device can participate in the WLAN sensing.

FIG. 3 is a flowchart of another communication method according to an example embodiment.

Referring to FIG. 3, in step 310, a first message frame is received. The first message frame may include information used to identify a capability which a device sending the first message frame can support in a wireless local area network (WLAN) sensing procedure.

According to an embodiment of the present disclosure, the capability information may include a first identification bit to identify a capability of the device supporting a sensing measurement based on a channel state information threshold.

According to an embodiment of the present disclosure, the capability information may further include a second identification bit to identify a role of the device in the WLAN sensing procedure.

According to an embodiment of the present disclosure, the second identification bit may include:
an initiator identification bit of a capability of the device supporting to act as an initiator in the WLAN sensing procedure;
a responder identification bit of a capability of the device supporting to act as a responder in the WLAN sensing procedure;
a transmitter identification bit of a capability of the device supporting to act as a transmitter in a sensing measurement phase of the WLAN sensing procedure; and
a receiver identification bit of a capability of the device supporting to act as a receiver in the sensing measurement phase.

According to an embodiment of the present disclosure, in the case where the device supports sub-7 GHz spectrum, and identification information to identify the device which supports the sub-7 GHz spectrum may be included in a capability information element of the first message frame, and the capability information may be included in an extended capability information element of the first message frame.

According to an embodiment of the present disclosure, in the case where the device supports 60 GHz spectrum, and the first message frame may include a directional multi-giga (DMG) capability information element or an enhanced DMG capability information element, and the capability information may be included in the DMG capability information element or the enhanced DMG capability information element.

Various embodiments described in above step 210 and embodiments described with reference to Tables 1 to 9 may be applied herein, and repeated descriptions thereof are omitted herein for brevity.

In step 320, a communication operation is performed based on the first message frame. For example, the device receiving the first message frame may obtain, by parsing the first message frame, various capabilities in the WLAN sensing of the device transmitting the first message frame from the capability information carried in the first message frame. For example, the device receiving the first message frame may perform the WLAN sensing based on the capability information in the first message frame. For example, in step 320, another message frame may be transmitted, and said another message frame may include information of a capability that the device transmitting said another message frame can support in the WLAN sensing procedure, so that the device transmitting said another message frame may exchange respective capability information with the device transmitting the first message frame to more effectively participate in WLAN sensing.

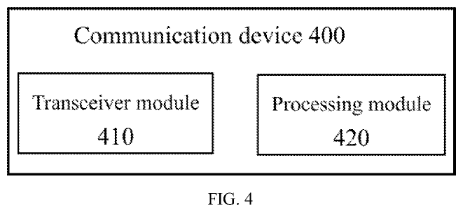

FIG. 4 is a block diagram of a communication device according to an example embodiment. The communication device 400 of FIG. 4 may include a processing module 410 and a transceiver module 420.

In the case where the communication device 400 of FIG. 4 may be applied to a transmitter in a communication process (e.g., an access process), the processing module 410 may be configured to determine a first message frame, wherein the first message frame may include information used to identify a capability which a device sending the first message frame can support in a wireless local area network (WLAN) sensing procedure; and the transceiver module 420 may be configured to transmit the first message frame. That is, the communication device 400 shown in FIG. 4 may perform the communication method described with reference to FIG. 2, and the embodiments described with reference to FIG. 2 and Tables 1 to 9 may be applied thereto, and repetitive descriptions thereof are omitted herein to avoid redundancy.

In the case where the communication device 400 shown in FIG. 4 may be applied to a receiver in a communication process (e.g., an access process), the transceiver module 420 may be configured to receive a first message frame, wherein the first message frame may include information used to identify a capability which a device sending the first message frame can support in a wireless local area network (WLAN) sensing procedure; and the processing module 410 may be configured to perform a communication operation based on the first message frame. That is, the communication device 400 shown in FIG. 4 may perform the communication method described with reference to FIG. 3, and the embodiments described with reference to FIG. 3 and Tables 1 to 9 may be applied thereto, and repetitive descriptions thereof are omitted herein to avoid redundancy.

It is to be understood that the communication device 400 shown in FIG. 4 is only exemplary, and the embodiments of the present disclosure are not limited thereto, e.g., the communication device 400 may also include other modules, e.g., a memory module. In addition, respective modules in the communication device 400 may be combined into a more complex module or may be divided into more separate modules.

The communication method and the communication device according to embodiments of the present disclosure cause the device to broadcast its own capability information value during the access process, so that the device participates in the WLAN sensing.

Based on the same principle as the method provided in the embodiments of the present disclosure, an embodiment of the present disclosure also provides an electronic device including a processor and a memory, wherein the memory stores machine-readable instructions (which may also be referred to as a “computer program”), and the processor is configured to execute the machine-readable instructions to implement the methods described with reference to FIGS. 2 and 3.

An embodiment of the present disclosure also provides a computer-readable storage medium having a computer program stored thereon, and the computer program when being executed by the processor, implements the methods described with reference to FIGS. 2 and 3.

In an example embodiment, the processor may be various exemplary logic boxes, modules, and circuits for implementing or executing what disclosed in the present disclosure, e.g., CPU (central processing unit), general purpose processor, DSP (digital signal processor), ASIC (application specific integrated circuit), FPGA (field programmable gate array) or other programmable logic devices, transistor logic devices, hardware components, or any combination thereof. The processor may also be a combination that implements computing functions, such as a combination including one or more microprocessors, a combination of a DSP and a microprocessor, and the like.

In an example embodiment, the memory may be, for example, ROM (read only memory), RAM (random access memory), EEPROM (electrically erasable programmable read only memory), CD-ROM (compact disc read only memory) or other optical disc storage, optical disc memory (including compact discs, laser discs, optical disc, digital versatile discs, blue-ray discs, or the like), magnetic storage media, or other magnetic storage devices, or devices that can be used to carry or store program code in the form of instructions or data structures and can be accessed by a computer, however the present disclosure is not limited thereto.

It is to be understood that although the steps in the flowchart of the accompanying drawings are shown sequentially as indicated by arrows, the steps are not necessarily performed sequentially in the order indicated by the arrows. Unless expressly stated herein, the execution of these steps is not strictly limited in order, and they may be executed in other orders. In addition, at least some of the steps in the flowchart of the accompanying drawings may include a plurality of sub-steps or a plurality of phases, which sub-steps or phases are not necessarily executed and completed at the same moment but may be executed at different moments, and the execution order thereof is not necessarily sequential, but may be executed in turn or alternately with at least some of the other steps, or of the sub-steps or phases of the other steps.

Although the present disclosure has been shown and described with reference to certain embodiments of the present disclosure, a person skilled in the art will appreciate that various changes in form and detail can be made without departing from the scope of the present disclosure. Accordingly, the scope of the present disclosure should be limited by the appended claims and their equivalents instead of being limited by the embodiments.

1. A communication method comprising:
determining a first message frame, wherein the first message frame comprises capability information used to identify a capability which a device sending the first message frame can support in a wireless local area network (WLAN) sensing procedure; and
transmitting the first message frame.

2. The communication method according to claim 1, wherein the capability information comprises a first identification bit to identify a capability of the device supporting a sensing measurement based on a channel state information threshold.

3. The communication method according to claim 2, wherein the capability information further comprises a second identification bit to identify a role of the device in the WLAN sensing procedure.

4. The communication method according to claim 3, wherein the second identification bit comprises at least one of:
an initiator identification bit of a capability of the device supporting to act as an initiator in the WLAN sensing procedure;
a responder identification bit of a capability of the device supporting to act as a responder in the WLAN sensing procedure;
a transmitter identification bit of a capability of the device supporting to act as a transmitter in a sensing measurement phase of the WLAN sensing procedure; and
a receiver identification bit of a capability of the device supporting to act as a receiver in the sensing measurement phase.

5. The communication method according to claim 1, wherein the device supports sub-7 GHz spectrum, and identification information to identify the device which supports the sub-7 GHz spectrum is comprised in a capability information element of the first message frame, and
wherein the capability information is comprised in an extended capability information element of the first message frame.

6. The communication method according to claim 1, wherein the device supports 60 GHz spectrum, and the first message frame comprises a directional multi-giga (DMG) capability information element or an enhanced DMG capability information element, and
wherein the capability information is comprised in the DMG capability information element or the enhanced DMG capability information element.

7. A communication method comprising:
receiving a first message frame, wherein the first message frame comprises capability information used to identify a capability which a device sending the first message frame can support in a wireless local area network (WLAN) sensing procedure; and
performing a communication operation based on the first message frame.

8. The communication method according to claim 7, wherein the capability information comprises a first identification bit to identify a capability of the device supporting a sensing measurement based on a channel state information threshold.

9. The communication method according to claim 8, wherein the capability information further comprises a second identification bit to identify a role of the device in the WLAN sensing procedure.

10. The communication method according to claim 9, wherein the second identification bit comprises at least one of:
an initiator identification bit of a capability of the device supporting to act as an initiator in the WLAN sensing procedure;
a responder identification bit of a capability of the device supporting to act as a responder in the WLAN sensing procedure;
a transmitter identification bit of a capability of the device supporting to act as a transmitter in a sensing measurement phase of the WLAN sensing procedure; and
a receiver identification bit of a capability of the device supporting to act as a receiver in the sensing measurement phase.

11. The communication method according to claim 7, wherein the device supports sub-7 GHz spectrum, and identification information to identify the device which supports the sub-7 GHz spectrum is comprised in a capability information element of the first message frame, and
wherein the capability information is comprised in an extended capability information element of the first message frame.

12. The communication method according to claim 7, wherein the device supports 60 GHz spectrum, and the first message frame comprises a directional multi-giga (DMG) capability information element or an enhanced DMG capability information element, and wherein the capability information is comprised in the DMG capability information element or the enhanced DMG capability information element.

13. (canceled)

14. (canceled)

15. An electronic device comprising a memory, a processor and a computer program stored on the memory and runnable on the processor, wherein the processor, when executing the computer program, implements acts comprising:
determining a first message frame, wherein the first message frame comprises capability information used to identify a capability which the device sending the first message frame can support in a wireless local area network (WLAN) sensing procedure; and
transmitting the first message frame.

16. A computer-readable storage medium, wherein the computer-readable storage medium has stored thereon a computer program that, when being executed by a processor, implements the method according to claim 1.

17. The electronic device according to claim 15, wherein the capability information comprises a first identification bit to identify a capability of the device supporting a sensing measurement based on a channel state information threshold.

18. The electronic device according to claim 17, wherein the capability information further comprises a second identification bit to identify a role of the device in the WLAN sensing procedure.

19. The electronic device according to claim 18, wherein the second identification bit comprises at least one of:
an initiator identification bit of a capability of the device supporting to act as an initiator in the WLAN sensing procedure;
a responder identification bit of a capability of the device supporting to act as a responder in the WLAN sensing procedure;
a transmitter identification bit of a capability of the device supporting to act as a transmitter in a sensing measurement phase of the WLAN sensing procedure; and
a receiver identification bit of a capability of the device supporting to act as a receiver in the sensing measurement phase.

20. The electronic device according to claim 15, wherein the device supports sub-7 GHz spectrum, and identification information to identify the device which supports the sub-7 GHz spectrum is comprised in a capability information element of the first message frame, and
wherein the capability information is comprised in an extended capability information element of the first message frame.

21. The electronic device according to claim 15, wherein the device supports 60 GHz spectrum, and the first message frame comprises a directional multi-giga (DMG) capability information element or an enhanced DMG capability information element, and
wherein the capability information is comprised in the DMG capability information element or the enhanced DMG capability information element.

22. An electronic device comprising a memory, a processor and a computer program stored on the memory and runnable on the processor, wherein the processor, when executing the computer program, implements the method according to claim 7.
